(19) United States
(12) Patent Application Publication
(10) Pub. No.: US 2020/0340827 A1
(43) Pub. Date: Oct. 29, 2020

(54) IMPOSSIBLE TURN INDICATION SYSTEM

(71) Applicant: Garmin International, Inc., Olathe, KS (US)

(72) Inventor: Joseph E. Gepner, Bonnor Springs, KS (US)

(21) Appl. No.: 16/395,830

(22) Filed: Apr. 26, 2019

(51) Int. Cl. G01C 23/00; B64D 45/08; B64D 43/02; G08G 5/00

(52) U.S. Cl. CPC G01C 23/005; B64D 45/08; B64D 2045/0085; G08G 5/0056; G08G 5/0091; B64D 43/02

(57) ABSTRACT

Aircraft indication systems and processes for calculating an engine-out return altitude for an aircraft are described. In implementations, an aircraft indication system comprises a memory operable to store one or more modules and a processor coupled to the memory. The processor is operable to execute the one or more modules to cause the processor to: identify a takeoff event associated with the aircraft; access dynamic aircraft performance data including at least a current altitude of the aircraft; calculate an engine-out return altitude for the aircraft; and provide a return altitude indication to a pilot of the aircraft using the calculated engine-out return altitude.

### BACKGROUND

An engine failure after takeoff can present a challenge for an aircraft pilot. The pilot must decide whether to immediately turn the aircraft to return to the runway or land the aircraft off the runway and away from the airport. Turning the aircraft to return to the runway in this scenario is often referred to as the “impossible turn” because sufficient altitude and/or airspeed must exist for the aircraft to return. Pilots are trained to evaluate flight options in the event of an engine failure after takeoff.

### SUMMARY

Aircraft indication systems and processes for calculating an engine-out return altitude for an aircraft are described. In implementations, an aircraft indication system comprises a memory operable to store one or more modules and a processor coupled to the memory. The processor is operable to execute the one or more modules to cause the processor to: identify a takeoff event associated with the aircraft; access dynamic aircraft performance data including at least a current altitude of the aircraft; calculate an engine-out return altitude for the aircraft; and provide a return altitude indication to a pilot of the aircraft using the calculated engine-out return altitude.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items.

FIG. 1 is an illustration depicting example “impossible turn” paths for an aircraft suffering an engine failure shortly after takeoff.

FIG. 2 is a table indicating the correlation between aircraft bank and stall speed for an example aircraft.

FIG. 3 is a table indicating the correlation between turn rate and total time to runway return for the example aircraft of FIG. 2.

FIG. 4 is an example illustration of an integrated avionics system, comprising one or more primary flight displays and one or more multi-function displays.

FIG. 5 is a block diagram of the example system of FIG. 4.

FIG. 6 is a block diagram depicting an example aircraft indication system suitable for use by embodiments of the present invention.

FIG. 7 is an illustration of a first example flight display screen provided by embodiments of the present invention, the display screen including a return altitude indication.

FIG. 8 is an illustration of a second example flight display screen provided by embodiments of the present invention, the display screen including a return altitude indication.

FIG. 9 is a flow diagram illustrating an exemplary process of calculating an engine-out return altitude.

### DETAILED DESCRIPTION

### Overview

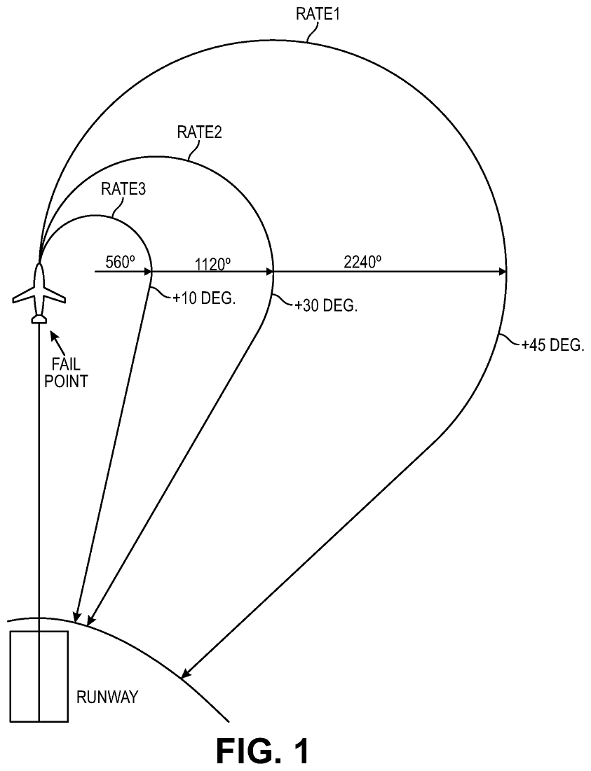

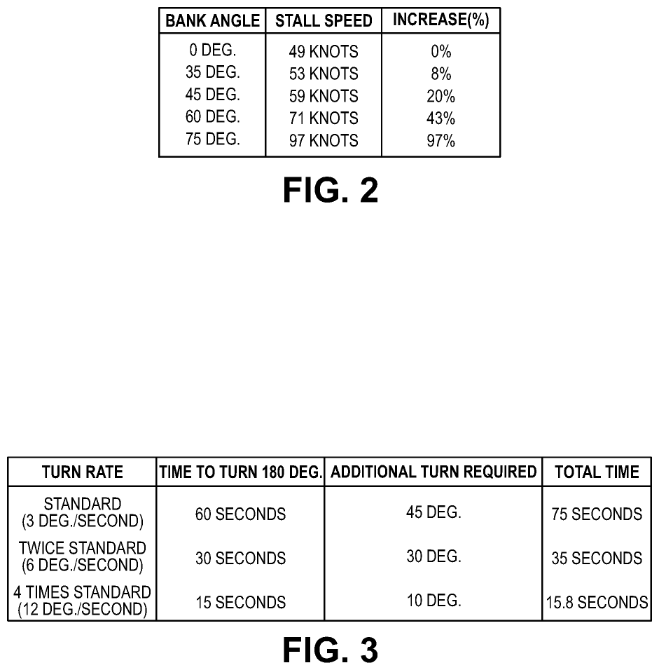

Referring to FIGS. 1-3, information from Federal Aviation Administration Document FAA-P-8740-44 regarding the so-called “impossible turn” is illustrated. FIG. 1 illustrates an example engine-out failure point for an aircraft shortly after takeoff and possible return paths to the runway. As shown in the data of FIG. 3, a steeper turn rate may return the aircraft more quickly (and with losing less altitude) than a more gradual turn rate. But, as shown in FIG. 2, a steeper turn rate caused by increased bank angle results in an increased stall speed—meaning the pilot must balance bank angle, turn rate, altitude, and airspeed. Unfortunately, this is often a difficult task.

Embodiments of the present invention provide systems and processes for calculating an engine-out return altitude for an aircraft. In implementations, an aircraft indication system comprises a memory operable to store one or more modules and a processor coupled to the memory. The processor is operable to execute the one or more modules to cause the processor to: identify a takeoff event associated with the aircraft; access dynamic aircraft performance data including at least a current altitude of the aircraft; calculate an engine-out return altitude for the aircraft; and provide a return altitude indication to a pilot of the aircraft using the calculated engine-out return altitude. In some implementations, the return altitude indication is presented on a primary flight display to inform the pilot of the altitude in which a return to the runway may be attempted. Additionally, a guidance cue may be provided to the pilot to aid the pilot in flying the aircraft on the return to the runway.

### Example Implementations

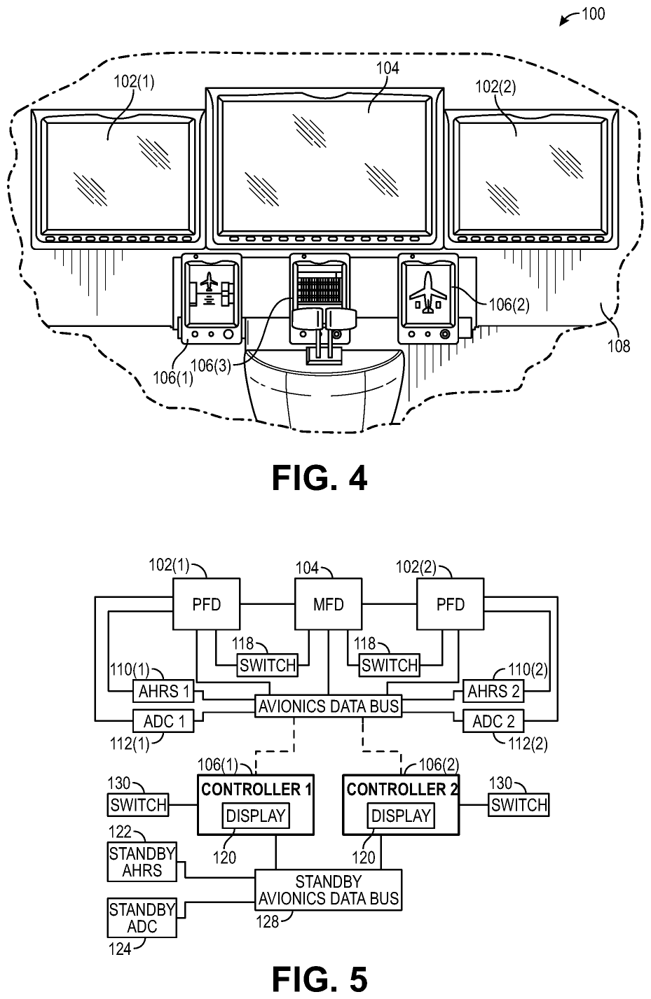

FIGS. 4-9 illustrate an example implementation of an aircraft indication system within an aircraft. In some embodiments, the aircraft indication system may be configured as an integrated avionics system 100. In other configurations, the aircraft indication system may comprise any panel-mount avionics or portable electronics. In implementations, the aircraft indication system may be configured as an electronic flight instrument, a flight display, a navigation device, a communications device, an altimeter, a vertical speed indicator, a horizontal situation indicator, an airspeed indicator, a compass or heading indicator, a tablet, an electronic flight bag, a computing device, a smartphone, a wearable electronic device such as a smartwatch, or any other device suitable for use within an aircraft.

The integrated avionics system 100 may include one or more primary flight displays (PFDs) 102, one or more multifunction displays (MFD) 104, and one or more multi-product avionics control and display units (CDU) 106. For instance, in the implementation illustrated in FIG. 1A, the integrated avionics system 100 may be configured for use in an aircraft that is flown by two pilots (e.g., a pilot and a copilot). In this implementation, the integrated avionics system 100 may include a first PFD 102(1), a second PFD 102(2), an MFD 104, a first CDU 106(1), a second CDU 106(2), and a third CDU 106(3) that are mounted in the aircraft's instrument panel 108. As shown, the MFD 104 is mounted generally in the center of the instrument panel 108 so that it may be accessed by either pilot (e.g., by either the pilot or the copilot). The first PFD 102(1) and the first CDU 106(1) are mounted in the instrument panel 108 generally to the left of the MFD 104 for viewing and access by the pilot. Similarly, the second PFD 102(2) and the second CDU 106(2) are mounted in the instrument panel 108 generally to the right of the MFD 104 for viewing and access by the aircraft's copilot or other crew member or passenger. The third CDU 106(3) may be mounted between the first and second CDUs 106(1), 106(2). In implementations, the CDUs 106 may be positioned within the instrument panel 108 so that they may be readily viewed and/or accessed by the pilot flying the aircraft (which could be either the pilot or copilot).

The PFDs 102 may be configured to display primary flight information, such as aircraft attitude, altitude, heading, vertical speed, and so forth. In implementations, the PFDs 102 may display primary flight information via a graphical representation of basic flight instruments such as an attitude indicator, an airspeed indicator, an altimeter, a heading indicator, a course deviation indicator, and so forth. The PFDs 102 may also display other information providing situational awareness to the pilot such as terrain information, ground proximity warning information, and so forth.

The primary flight information may be generated by one or more flight sensor data sources including, for example, one or more attitude, heading, angular rate, and/or acceleration information sources such as attitude and heading reference systems (AHRS) 110, one or more air data information sources such as air data computers (ADCs) 112, and/or one or more angle of attack information sources. For instance, the AHRSs 110 may be configured to provide information such as attitude, rate of turn, slip and skid; while the ADCs 112 may be configured to provide information including airspeed, altitude, vertical speed, and outside air temperature. Other configurations are possible.

Integrated avionics units (IAUs) may aggregate the primary flight information from the AHRS 110 and ADC 112 and, in one example configuration, provide the information to the PFDs 102 via an avionics data bus 116. In other examples, the various IAUs may directly communicate with either other and other system components. The IAUs may also function as a combined communications and navigation radio. For example, the IAUs may include a two-way VHF communications transceiver, a VHF navigation receiver with glide slope, a global positioning system (GPS) receiver, and so forth. As shown, each integrated avionics unit may be paired with a primary flight display, which may function as a controlling unit for the integrated avionic unit. In implementations, the avionics data bus 116 may comprise a high speed data bus (HSDB), such as data bus complying with ARINC 429 data bus standard promulgated by the Airlines Electronic Engineering Committee (AEEC), a MIL-STD-1553 compliant data bus, and so forth. A radar altimeter may be associated with one or more of the IAUs, such as via data bus 116 or a direct connection, to provide precise elevation information (e.g., height above ground) for autoland functionality. For example, in some configurations, the system 100 includes a radar altimeter to assist an autoland module in various functions of the landing sequence, such as timing and maintaining the level-off and/or flare.

The MFD 104 displays information describing operation of the aircraft such as navigation routes, moving maps, engine gauges, weather radar, ground proximity warning system (GPWS) warnings, traffic collision avoidance system (TCAS) warnings, airport information, and so forth, that are received from a variety of aircraft systems via the avionics data bus 116.

The CDUs 106 may furnish a general purpose pilot interface to control the aircraft's avionics. For example, the CDUs 106 allow the pilots to control various systems of the aircraft such as the aircraft's autopilot system, flight director (FD), electronic stability and protection (ESP) system, autothrottle, navigation systems, communication systems, engines, and so on, via the avionics data bus 116. In implementations, the CDUs 106 may also be used for control of the integrated avionics system 100 including operation of the PFD 102 and MFD 104.

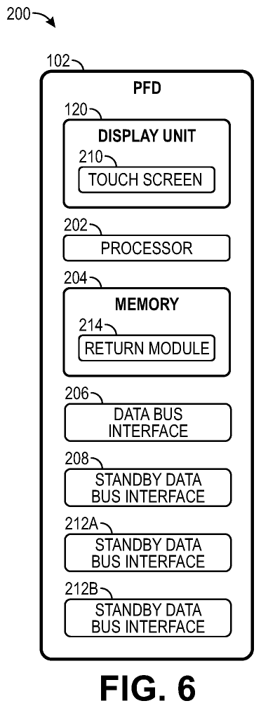

FIG. 6 illustrates an aircraft indication system 200 in an example implementation showing a representative PFD 102 of FIG. 5 in greater detail. The PFD 102 is illustrated as including a processor 202, a memory 204, one or more avionics data bus interfaces 206, 208 and display 120. System 200 comprising PFD 102 may comprise part of system 100 or be configured as a standalone avionics device.

Memory 204 may include return module 214, which is capable of execution by processor 202 to provide various return indication functionality described herein. Return module 214 may be incorporated within any memory element of system 100 or any other electronic device. For instance, return module 214 may be executed by PFD 102(2), MFD 104, any other unit associated with system 100, and/or portable electronic devices such as a tablet, smartphone, wearable electronic device such as a smartwatch, or handheld electronic device. Return module 214 may be configured as an app for execution by an electronic flight bag, experimental avionics devices, or any integrated avionics device.

The processor 202 provides processing functionality for the PFD 102 and may include any number of processors, micro-controllers, or other processing systems and resident or external memory for storing data and other information accessed or generated by the PFD 102. The processor 202 may execute one or more software programs which implement techniques described herein. The processor 202 is not limited by the materials from which it is formed or the processing mechanisms employed therein, and as such, may be implemented via semiconductor(s) and/or transistors (e.g., electronic integrated circuits (ICs)), and so forth.

The memory 204 is an example of computer-readable media that provides storage functionality to store various data associated with the operation of the PFD 102, such as the software programs and code segments mentioned above, or other data to instruct the processor 202 and other elements of the PFD 102 to perform the functionality described herein. Although a single memory 204 is shown, a wide variety of types and combinations of memory may be employed. The memory 204 may be integral with the processor 202, stand-alone memory, or a combination of both. The memory 204 may include, for example, removable and non-removable memory elements such as RAM, ROM, Flash (e.g., SD Card, mini-SD card, micro-SD Card), magnetic, optical, USB memory devices, and so forth.

The avionics data bus interface 206 and the standby avionics data bus interface 208 furnish functionality to enable the PFD 102 to communicate with one or more avionics data buses such as the avionics data bus 116 and standby avionics data bus 128, respectively, illustrated in FIG. 1B. In various implementations, the avionics data bus interface 206 and standby avionics data bus interface 208 may include a variety of components, such as processors, memory, encoders, decoders, and so forth, and any associated software employed by these components (e.g., drivers, configuration software, etc.).

The display 120 displays information to the pilot of the aircraft. In implementations, the display 120 may comprise an LCD (Liquid Crystal Diode) display, a TFT (Thin Film Transistor) LCD display, an LEP (Light Emitting Polymer or PLED (Polymer Light Emitting Diode)) display, a cathode ray tube (CRT), and so forth, capable of displaying text and/or graphical information, such as a graphical user interface. The display 120 may be backlit via a backlight such that it may be viewed in the dark or other low-light environments.

The display 120 may include a touch interface, such as a touch screen 210, that can detect a touch input within a specified area of the display 120 for entry of information and commands In implementations, the touch screen 210 may employ a variety of technologies for detecting touch inputs. For example, the touch screen 210 may employ infrared optical imaging technologies, resistive technologies, capacitive technologies, surface acoustic wave technologies, and so forth. In implementations, buttons, softkeys, keypads, knobs and so forth, may be used for entry of data and commands instead of or in addition to the touch screen 210.

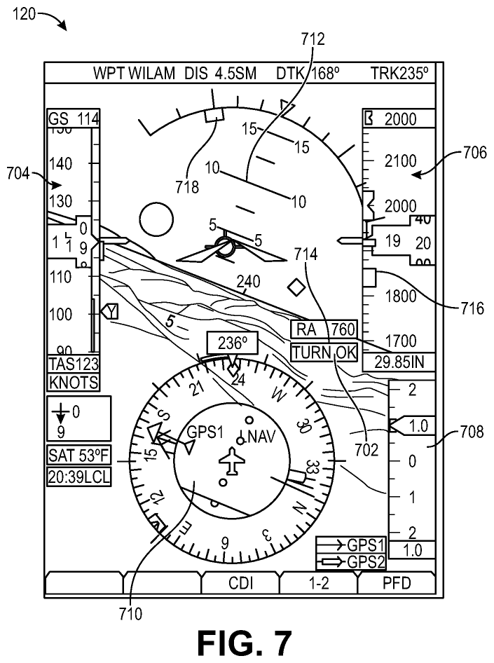

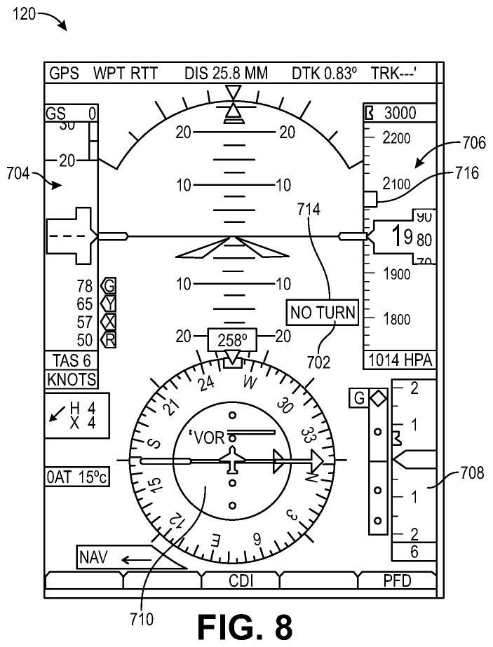

In one or more implementations, the return module 214 provides functionality to provide a return altitude indication to a pilot. As illustrated within FIGS. 7 and 8, the return altitude indication 702 may be presented on display 120 viewable by the pilot. Display 120 may include various flight information in addition to return altitude indication 702, including for example: an airspeed indicator 704, an altitude indicator 706, a vertical speed indicator 708, a horizontal situational indicator 710, pitch information 712, and the like. Display 120 may be presented by the various electronic devices discussed above, including for instance PFD 102, MFD 104, CDU 106, a portable electronic device, an electronic flight bag, combinations thereof, and the like. Data corresponding to the various indicators 704-712 may be acquired through the avionics databus 116, 128 and/or internally generated by the processor 202 executing the return module 214.

In the examples of FIGS. 7 and 8, return altitude indication 702 is provided as an annunciation 714 (“TURN OK”) on the display 120 of PFD 102. The annunciation 714 of FIG. 7 is presented on the display 120 so it may be easily viewed by the pilot during takeoff and departure. For example, “TURN OK” indicates to the pilot that the return module 214 has calculated that a return to the departure runway (and/or airport) is possible even if the pilot's aircraft is no longer generating thrust. Annunciation 714 of FIG. 8 (“NO TURN”) indicates that the return module 214 has calculated that a return to the departure runway (and/or airport) is not desirable if the pilot's aircraft is no longer generating thrust.

In addition to, or as an alternative to, annunciation 714, the return altitude indication 702 may be presented as an altitude bug 716 on the altitude indicator 706. For example, in the illustrated embodiments where altitude indicator 706 is an altitude tape, altitude bug 716 indicates to the pilot the altitude at which return module 214 has calculated that an engine-out return to the airport (and/or runway) is possible. Altitude bug 716 enables the pilot to determine during takeoff and departure not only if an engine-out return to the runway/airport is advisable, but also the extent to which the pilot's aircraft is above or below that return altitude. In configurations, module 214 can additionally or alternatively generate a guidance cue 718 to assist the pilot in an engine-out path back to the runway or airport. In the examples of FIGS. 7 and 8, guidance cue 718 is presented as a bug on the bank indicator of display 120.

Return altitude indication 702 may additionally or alternatively be presented to pilot on any number of displays associated with aircraft of pilot (e.g., portable displays, heads-up displays, augmented displays, integrated displays, etc.). In some configurations, return altitude module 214 is configured to generate an audio cue (e.g., prompt, chime, voice alert, etc.) for audible reception by the pilot. For example, return altitude module 214 can interface with a pilot's headset through an audio panel to generate a prompt (“TURN OK”) or related chime for pilot. Likewise, return altitude module 214 can interface with other audio sources in the cockpit, e.g., a cockpit speaker, to generate the audio cue or related chime.

In embodiments, return altitude module 214 can interface with an autopilot associated with system 100 to automatically pilot the aircraft in response to generation of the return altitude indication 702. Thus, for instance, if system 100 detects an engine failure it may automatically trigger the autopilot and return the aircraft to the departing runway/airport upon determination by the return altitude module 214 that such a return is feasible.

### Example Processes

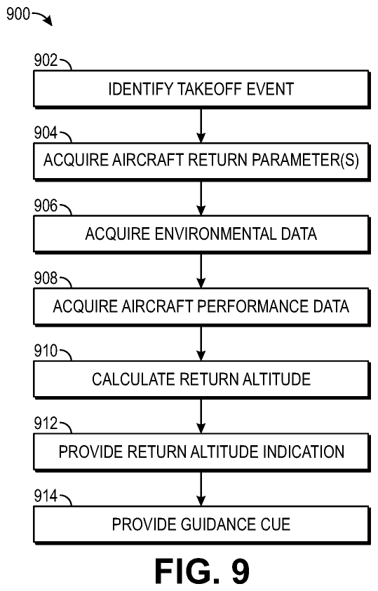

FIG. 9 depicts an example process 900 for generating a return altitude indicator, such as by using the return altitude module 214 described above. As shown in FIG. 9, return altitude module 214 may identify a takeoff event (Block 902), access aircraft return parameters (Block 904), acquire environmental data (Block 906), acquire aircraft performance data (Block 908), calculate return altitude (Block 910), provide return altitude indication 702 (Block 912), and/or provide a guidance cue (Block 914). The various functions depicted in FIG. 9 need not be performed in any particular order, may be performed simultaneously, may be performed by any component of system 100, and may be optional.

Return altitude module 214 may identify a takeoff event (Block 902) to assist with calculation of the return altitude indication 702 and/or guidance cue 718. In configurations, generation of return altitude indication 702 is unnecessary when the aircraft is on the ground, taxing, and/or in a stage of flight where indication 702 is unnecessary or unhelpful (e.g., when aircraft is at cruise and far from the departure airport). Thus, identifying the takeoff event can reduce aggravation caused by unnecessary generation of indication 702.

Module 214 may identify a takeoff event utilizing one or more functions. In one example, module 214 receives the take event indication from another component of system 100, such as a PFD 102, MFD 104, transponder, ADC 112, etc., that has determined that the pilot's aircraft is taking off, or has taken off, in order to provide aviation functionality (e.g., transponder activation) unrelated to embodiments of the present invention.

In other configurations, module 214 may identify the takeoff event utilizing various sensor and/or position information. For example, module 214 may identify that a takeoff event has occurred by: (a) receiving information from a weight-on-wheels sensor that the aircraft is no longer on the ground; (b) receiving information from a GPS or other position source that the aircraft is moving above a threshold vertical speed or has climbed a threshold altitude; (c) receiving information from an airspeed indicator that the aircraft has achieved a threshold airspeed indicating takeoff; (d) receiving information from a barometric pressure indicator that indicates a change in aircraft altitude; (e) receiving an input from the pilot that the takeoff event will or has occurred; (f) combinations thereof and the like.

Module 214 may access aircraft return parameters (Block 904) to assist in calculation of the aircraft return altitude (Block 910). In embodiments, aircraft return parameters include data corresponding to an aerodynamic profile of the aircraft, such as a stall profile indicating the airspeeds at which the aircraft will stall for a given bank angle. An example stall profile is illustrated in FIG. 2. Aircraft return parameters may be stored in memory 204 and/or within any avionics associated with system 100, including portable avionics such as a smartphone containing a stall profile of the pilot's aircraft. Aircraft return parameters may additionally or alternatively include turn-rate data such as the example information illustrated in FIG. 3, V-speeds for the aircraft, and/or a glide profile (e.g., glide ratio) of the aircraft, such as the amount of horizontal distance the aircraft may glide for each foot of vertical altitude lost. Aircraft return parameters may include any data associated with aircraft that relates to the engine-out performance of the aircraft and its ability to maneuver in engine-out configurations. Thus, aircraft return parameters may additionally include data such as airspeed information (minimum maneuvering speed), angle-of-attack limits, attitude information such as a pitch, bank, and roll limits, combinations thereof, and the like.

Module 214 may acquire environmental data (Block 906) to assist in calculation of the aircraft return altitude (Block 910). The environmental data may include weather-related information, such as wind speed and wind direction. Wind speed and wind direction may impact the aircraft's glide range and ability to maneuver in engine-out configurations. Additionally or alternatively, the environmental data may include terrain information, indicating the location, height (altitude), size, and type of geographical features and other obstacles. Terrain information may impact the path needed to return the aircraft to the departure airport/runway. For example, a mountain between the current geographic location of the aircraft and the departure runway will impact the glide path needed to be followed by the aircraft. Likewise, terrain features such as water and obstacles such as buildings or towers may impact the flight path.

Environmental data may be stored in memory 204 and/or within any avionics associated with system 100, including portable avionics such as a smartphone containing a terrain database and/or weather information. Thus, for example, terrain information may be associated with a terrain awareness and warning system (TAWS) database utilized by PFD 102. Terrain information may also include the altitude of the departure end of the departure runway or other altitudes associated with the departure runway. The altitude of the departure runway may be determined by saving the altitude of the aircraft at the determined takeoff event (Block 902) within memory 204, by accessing the altitude of the departure runway from a terrain database such as the TAWS database, by receiving an input from the pilot corresponding to the altitude of the departure runway, from a stored flight plan within memory 204, combinations thereof, and the like.

Weather-related information, including real-time weather information indicating current wind speed and direction, may be acquired from memory 204, other components of avionics system 100 including portable devices such as a smartphone, through onboard aircraft sensors, and/or through a datalink associated with system 100 and/or associated portable electronic devices. Weather-related information may also be calculated by module 214 from available sensor information. For example, wind speed and direction may be inferred from the difference between ground speed and airspeed.

Module 214 may acquire aircraft performance data (Block 908) to assist in calculation of the aircraft return altitude (Block 910) and/or guidance cue (Block 914). Aircraft performance data may include dynamic aircraft performance data associated with the current performance of the aircraft, which in turn relates to the aircraft's ability to return to the departure airport/runway during engine-out conditions. In embodiments, the dynamic aircraft performance data includes at least a current altitude of the aircraft. The current altitude of the aircraft may correspond to the aircraft's height above sea level (MSL) and/or height above ground as calculated using MSL, the aircraft's current geographic position, and/or the terrain data acquired in Block 906. In embodiments, the dynamic aircraft performance data may additionally or alternatively include an airspeed of the aircraft, an attitude of the aircraft, a ground speed of the aircraft, a heading of the aircraft, a geographic location of the aircraft, angle of attack, and a bank angle of the aircraft, combinations thereof, and the like. The available dynamic aircraft performance data may vary based on the particular configuration of system 100 and aircraft, such as what sensor data is available to module 214. Thus, for example, in configurations where module 214 is executed by a smartphone as an app, the dynamic performance data may include only GPS-derived altitude (MSL, height-above-ground, ground speed, etc.) The aircraft performance data may additional include a current configuration of the aircraft, such as the position of flaps, the status of landing gear, and the feather position of propellers.

Aircraft performance data may be stored in memory 204 and/or within any avionics associated with system 100, including portable avionics. In embodiments, module 214 is capable of accessing the performance data utilized elsewhere by PFD 102 and/or other components of system 100, including real-time data from sensors such as an airspeed sensor, a GPS receiver, an AHRS/attitude sensor, a barometric pressure/altitude sensor, a heading sensor, combinations thereof, and the like. Such information may be acquired by module 214 using the databus 116, 128 and/or through direct connection with one or more sensors.

Module 214 may calculate return altitude (Block 910) using any combinations of the data acquired in Blocks 902-908. Return altitude is an estimate of the altitude the pilot's aircraft must reach to return the departure runway in an engine-out configuration. Knowledge of the return altitude, and a comparison of the aircraft's current altitude to the return altitude, enables the pilot and/or system 100 to determine if a turn should be made to return to the departure runway or if a landing attempt should be made directly in front of aircraft. Departure runway, as used herein, can refer to the actual runway the aircraft departed from or the general environment, such as the taxiways, tarmacs, other runways, parking areas, landscape areas surrounding the runway, etc.

Return altitude can be calculated by module 214 utilizing various functions. In one embodiment, return altitude can be calculated by adding an altitude value to the altitude of the departure runway acquired in Block 906. For example, 1000 feet, or any pilot-selectable value, can be added to the altitude of the departure runway to determine the return altitude.

Return altitude may additionally or alliteratively be calculated by estimating the glide range of the aircraft. For example, module 214 may access aircraft return parameters (Block 904) to calculate return altitude by calculating the time and/or distance needed to make the turn and return to the runway before reaching the ground. Thus, for example, stall speeds, glide ratio, and/or other performance characteristics can dictate the return altitude. Return altitude may be calculated in advance of takeoff by assuming standard departure velocities, as described below, and/or be continuously updated in real-time to reflect additional metrics. Thus, in configurations, return module 214 may present a first return altitude to the pilot during taxi and run-up, to enable the pilot to brief the return altitude as part of a takeoff procedure. Return module 214 may then later update the first return altitude after takeoff, to calculate a second return altitude, based on other data available to system 100 such as the current speed, position, configuration, etc., of the aircraft.

Environmental data (Block 906) and performance data (Block 908) can impact the calculation of the return altitude. For example, wind speed and direction impact the performance of the aircraft in an engine-out configuration. Likewise terrain between the aircraft and departure runway may prevent the aircraft from flying a standard return path. Module 214 can calculate the impact environmental data has on aircraft glide performance and calculate the return altitude accordingly. For example, the return altitude can be increased to account for headwinds on the return path or obstacles that must be avoided.

Aircraft performance data (Block 908), including current aircraft location, can also impact the calculation of the return altitude. In configurations, module 214 may calculate the glide range for the aircraft based the aircraft return parameters and compare that glide range to the current range to the departure runway to calculate the return altitude. In other configurations, module 214 may calculate the return altitude by assuming a best rate or best angle of departure by the pilot and estimating the glide range to return the runway at any position along that ideal departure. Additionally or alternatively, aircraft airspeed (deviations from the best angle or best rate departures) can impact return altitude. For example, a fast-moving aircraft can trade airspeed for altitude and extend its glide range. Inversely, a slow-moving aircraft may have a more limited glide range than a faster aircraft. Likewise, aircraft attitude, angle of attack, heading, and/or bank angle may impact the calculated glide range. For example, an aircraft that is in a stall configuration will have a more limited glide range in an engine-out configuration that an aircraft in a typical engine-out configuration. Aircraft configuration, such as whether it's in a “clean” configuration with gear retracted and flaps up or a “dirty” configuration with flaps and gear down, can also impact glide range by impacting the drag characteristics of the aircraft.

Module 214 can provide return altitude indication 702 (Block 914). The return altitude indication 702 may be the value of the calculated return altitude (e.g., 2,000 feet), an indication whether a return is desirable (e.g., “TURN OK”), a bug or other indication on an altitude display, and audible cue or chime, including a text-to-speech output of the calculated return altitude, combinations thereof, and the like. The return altitude indication 702 may be presented by or on any component of system 100, including portable electronic devices such as tablets or smartphones. Example return altitude indications 702 are described above in connection with FIGS. 7 and 8, including the annunciation 714 and altitude bug 716 provided on display 120 of PFD 102.

Whether the return altitude indication 702 is presented, and the nature and content of its presentation, may vary based on information associated with the aircraft. For example, module 214 may compare the current altitude of the aircraft to the calculated return altitude to determine whether “TURN OK” or “NO TURN” (or other related language) is presented to the pilot visually or audibly. Likewise, upon reaching the return altitude, module 214 may generate an audible chime or audible alert for the pilot that a return is possible. Module 214 may also change the color of the displayed return altitude indication 702 or provide other visual cues upon reaching the calculated return altitude. Return altitude indication 702 may be updated in real-time during takeoff and departure to reflect updated values of the calculated return altitude.

Presentation of the return altitude indication 702, including whether and how the indication 702 is presented by module 214, may vary based on information provided by system 100 to module 214. For example, module 214 may identify an engine-out event to determine whether and how to provide indication 702. Module 214 may access engine-related information from system 100, such as engine operation information through the avionics databuses and/or via direct connection to a digital engine controller (FADEC), to identify the engine-out event and determine whether to present indication 702. Upon determining that an engine failure or engine-out condition exists, module 214 may generate the indication 702 so the pilot can be assisted in determining whether to make the return to the departure runway. In such a scenario, the size, color, intensity, and/or volume of indication 702 may additionally be increased upon module 214 receiving an indication of an engine-out situation or other engine failure.

Module 214 may provide guidance cue 718 (Block 916). The guidance cue 718 may be visually or audibly presented by module 214 to provide information that would assist the pilot in properly turning towards the departure runway. In embodiments, the guidance cue 718 may include a bank angle indicator indicating the desired bank angle for the aircraft to turn at to reach the departure runway according to the estimated return altitude. For example, the guidance cue 718 may be colored tick on a heading or bank indicator, and audible cue or alert indicating the desired bank angle, and/or other presentation indicating the desired bank to be flown. Guidance cue 718 may additionally include an airspeed indication, such as a tick on the airspeed tape of PFD 102, to allow the pilot to maintain best glide speed while returning to the departure runway. Guidance cue 718 may additionally include pitch information, such as a cue on pitch information 712 to assist the pilot in maintaining best glide speed or other airspeed and altitude targets.

The guidance cue 718 can be calculated using aircraft performance data, such as current airspeed, altitude, heading, angle of attack, etc. Thus, for instance, guidance cue 718 can account for the current status of the aircraft to assist in flying the aircraft back to the departure runway while maintaining flight within the aircraft's operating envelope. For example, guidance cue 718 can be continuously updated to maintain the desired airspeed and bank to return the aircraft to the departure runway. Guidance cue 718 may additionally utilize other information available to module 214, such as terrain information, to assist in piloting the aircraft to departure runway.

Guidance cue 718 may be calculated by module 214 itself and/or be acquired from module 214 from other components of system 100. For example, the system's 100 autopilot, envelope protection, or autolanding functions may calculate a return path to the departure runway that is provided to module 214 for display as guidance cue 718. Module 214 may additionally or alternatively provide the calculate return altitude and/or information associated with guidance cue 718 to other components of system 100, such as the autopilot, to enable the aircraft to automatically fly a return path to the departure runway in accord with the return altitude and the calculated guidance cue 718.

### Conclusion

Although the aircraft indication system and module 214 have been described with reference to example implementations illustrated in the attached drawing figures, it is noted that equivalents may be employed and substitutions made herein without departing from the scope of the invention as recited in the claims. For example, the integrated avionics system 100, including respective components, as illustrated and described herein is merely an example of a system and components that may be used to implement the present disclosure and may be replaced with other devices and components without departing from the scope of the present disclosure.

What is claimed is:

1. An aircraft indication system for an aircraft, the system comprising:
a memory operable to store one or more modules; and
a processor coupled to the memory, the processor operable to execute the one or more modules to cause the processor to:
identify a takeoff event associated with the aircraft;
access dynamic aircraft performance data including at least a current altitude of the aircraft;
calculate an engine-out return altitude for the aircraft; and
provide a return altitude indication to a pilot of the aircraft using the calculated engine-out return altitude and the current altitude of the aircraft.

2. The system of claim 1, wherein the processor is further operable to execute the one or more modules to:
acquire environmental data including wind speed and direction; and
calculate the engine-out return altitude using the environmental data.

3. The system of claim 1, wherein the processor is further operable to execute the one or more modules to:
acquire environmental data including terrain information; and
calculate the engine-out return altitude using the environmental data.

4. The system of claim 1, wherein the processor is further operable to execute the one or more modules to:
acquire aircraft return parameters including a stall profile of the aircraft; and
calculate the engine-out return altitude using the aircraft return parameters.

5. The system of claim 1, wherein the dynamic aircraft performance data further includes at least one of an airspeed of the aircraft, an attitude of the aircraft, an angle of attack of the aircraft, a ground speed of the aircraft, a geographic location of the aircraft, a heading of the aircraft, and a bank angle of the aircraft.

6. The system of claim 1, further including a primary flight display coupled with the processor, wherein the return altitude indication is presented on the primary flight display.

7. The system of claim 6, wherein the return altitude indication is presented on an altitude tape displayed by the primary flight display.

8. The system of claim 1, wherein the return altitude indication is an audio cue generated by the processor.

9. An aircraft indication system for an aircraft, the system comprising:
a primary flight display;
a memory operable to store one or more modules; and
a processor coupled to the memory and the primary flight display, the processor operable to execute the one or more modules to cause the processor to:
identify a takeoff event associated with the aircraft;
acquire environmental data including wind speed and direction;
access dynamic aircraft performance data including at least a current altitude of the aircraft;
calculate an engine-out return altitude for the aircraft using at least the environmental data; and
control the primary flight display to provide a visual return altitude indication to a pilot of the aircraft using the calculated engine-out return altitude and the current altitude of the aircraft.

10. The system of claim 9, wherein the processor is further operable to execute the one or more modules to:
acquire environmental data including terrain information; and
calculate the engine-out return altitude using the terrain information.

11. The system of claim 9, wherein the processor is further operable to execute the one or more modules to:
acquire aircraft return parameters including a stall profile of the aircraft; and
calculate the engine-out return altitude using the aircraft return parameters.

12. The system of claim 9, wherein the dynamic aircraft performance data further includes at least one of an airspeed of the aircraft, an attitude of the aircraft, an angle of attack of the aircraft, a ground speed of the aircraft, a geographic location of the aircraft, a heading of the aircraft, and a bank angle of the aircraft.

13. The system of claim 9, wherein the return altitude indication is presented on an altitude tape displayed by the primary flight display.

14. The system of claim 9, wherein the processor is further configured to provide the return altitude indication as an audio cue through an audio panel associated with the primary flight display.

15. An aircraft indication system for an aircraft, the system comprising:
a primary flight display;
a memory operable to store one or more modules; and
a processor coupled to the memory and the primary flight display, the processor operable to execute the one or more modules to cause the processor to:
identify a takeoff event associated with the aircraft;
identify an engine-out event associated with the aircraft;
acquire environmental data including wind speed and direction; and
access dynamic aircraft performance data including at least a current altitude and airspeed of the aircraft;
calculate an engine-out return altitude for the aircraft using at least the dynamic aircraft performance data and the environmental data;
control the primary flight display to provide a visual return altitude indication to a pilot of the aircraft using the calculated engine-out return altitude and the current altitude of the aircraft; and
if the processor identified the engine-out event, calculate a guidance cue, the guidance cue indicating at least a bank angle for the aircraft, wherein the guidance cue is presented by the primary flight display.

16. The system of claim 15, wherein the guidance cue further includes an airspeed for the aircraft.

17. The system of claim 15, wherein the processor is further operable to execute the one or more modules to:
acquire aircraft return parameters including a stall profile of the aircraft, the stall profile including a stall speed for the aircraft; and
calculate the engine-out return altitude using the stall profile of the aircraft.

18. The system of claim 15, wherein the return altitude indication is presented on an altitude tape displayed by the primary flight display.

19. The system of claim 15, wherein the processor is further configured to provide the return altitude indication as an audio cue through an audio panel associated with the primary flight display.

20. The system of claim 15, wherein the processor is further operable to execute the one or more modules to:
acquire environmental data including terrain information; and
calculate the engine-out return altitude using the terrain information.
